(19) United States
(12) Patent Application Publication
(10) Pub. No.: US 2012/0290767 A1
(43) Pub. Date: Nov. 15, 2012

(54) APPARATUS AND METHOD FOR PROVIDING APPLICATION SERVICE USING EXTERNAL MEMORY

(75) Inventors: Sung Woo Park, Seoul (KR); Jae Hoon Jung, Hwaseong (KR)

(73) Assignees: KIA MOTORS CORPORATION, Seoul (KR); HYUNDAI MOTOR COMPANY, Seoul (KR)

(21) Appl. No.: 13/240,459

(22) Filed: Sep. 22, 2011

(30) Foreign Application Priority Data
May 12, 2011 (KR) 10-2011-0044802

(51) Int. Cl. G06F 12/00

(52) U.S. Cl. 711/103; 711/115; 711/E12.008

(57) ABSTRACT

An apparatus and a method for providing an application service using an external flash memory is provided. More specifically, the apparatus and method that enables a user to receive provisions of an application service without installing a corresponding application program on an application service providing device (such as an audio-display module) by directly executing a corresponding application program from a USB memory device in which an application program such as a navigation program or an electronic book program is connected therewith to provide an application service to a user.

### CROSS-REFERENCES TO RELATED APPLICATIONS

Priority to Korean patent application number 10-2011-0044802, filed on May 12, 2011, which is hereby incorporated by reference in its entirety, is claimed.

### BACKGROUND OF THE INVENTION

1. Field of the Invention

The present invention relates to an apparatus and a method for providing an application service using an external memory, and more particularly, to an apparatus and a method for providing an application service using an external memory that directly executes a corresponding application program as an USB memory in which an application program such as a navigation program or an electronic book program is connected therewith to provide an application service to a user.

2. Description of the Related Art

A Universal Serial Bus (USB) a bus standard (a transmission path of data) used in exchanging data between a computer and a peripheral device. USBs have been used as early as the late 1990s since their supply rate of is very high as comparison with that of buses of other current bus standards and because the USB device may be easily inserted into most of computers and used without being installed by the user. Further, since the USB may be freely inserted and separated into and from the computer (even when the computer is powered off), USB devices have also very convenient.

A flash memory is a type of semiconductors that may store/keep data. Unlike Read-only memory (ROM) or Random-access Memory (RAM), flash memory may freely store and delete data and maintain data whether or not the power is turned-off. For example, if data is stored on a ROM, it is impossible to remove or correct the data. Furthermore, although it is possible to remove/correct data from a RAM, all data on the RAM is deleted once power is cut-off to the RAM.

An USB flash drive is one product which is made of a combination of a USB and a flash memory, which is generally called USB memory. The USB memory includes a stick type body having the size of about one finger and an USB connector exposed from the stick type body. The USB memory is composed of a flash memory chip which is configured to store data and a controller configured to control the data transmission between a connector and a memory chip therein.

There is a need for an approach capable of simply providing an application service efficiently using the USB memory.

### SUMMARY OF THE INVENTION

The present invention has been made in view of the above problems, and provides an apparatus and a method for providing an application service using an external memory that enables a user to receive provisions of an application service without installing a corresponding application program in an application service providing device by directly executing a corresponding application program such as an USB memory in which an application program (for example, a navigation program or an electronic book program) is connected therewith to provide an application service to a user.

In accordance with an aspect of the present invention, an apparatus for providing an application service using an external memory in an application service providing device included in a vehicle includes: an USB connection unit to which an USB memory is connected, an application program installed on the USB memory; a connection sensing unit configured to sense the connection of the USB memory; a controller configured to execute an application program installed on the USB memory when connection of the USB memory is sensed; and an application service providing unit configured to provide an application service corresponding to the application program executed by the controller to a user from the USB memory.

In accordance with another aspect of the present invention, an apparatus for providing an application service in a vehicle includes: an USB connecting unit to which an USB memory is connected, an application program installed on the USB memory; a connection sensing unit configured to sense the connection of the USB memory; a controller configured to check an operating system of an application program installed on the USB memory when the connection of the USB memory is sensed, and execute the application program when the checked operating system of an application program is identical with that of an application service providing device belonging to the controller; and an application service providing unit configured to provide an application service corresponding to the application program executed by the controller to a user.

In accordance with another aspect of the present invention, a method for providing an application service in an application service providing device included in a vehicle includes: sensing, by a connection sensing unit, a connection of an USB memory in which an application is installed; checking, by a controller, an operating system of an application program installed on the USB memory; executing, by the controller, the application program when the checked operating system of an application program is identical with that of the application service providing device; providing an application service corresponding to the executed application program; and terminating, by the controller, the application program when the operating system of the application program differs from that of the application service providing device.

Accordingly, the present invention provides an application service using an external memory that enables a user to receive provisions of an application service without installing a corresponding application program in an application service providing device itself, through directly executing a corresponding application program through USB memory in which an application program such as a navigation program or an electronic book program is connected therewith to provide an application service to a user.

In addition, the present invention can be used with an apparatus for providing an application service installed in another user's vehicle as if it is user's own apparatus for providing an application service by inserting his or her USB memory into the second user's apparatus for providing an application server. In particular, the application service is run by directly executing a corresponding application program via the user's USB memory in which an application program such as a navigation program or an electronic book program is connected therewith to provide an application service to a user.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a configuration of an apparatus for providing an application service using an external memory according to an exemplary embodiment of the present invention; and

FIG. 2 is a flowchart illustrating a method for providing an application service using an external memory according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

Unless specifically stated or obvious from context, as used herein, the term “about” is understood as within a range of normal tolerance on the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

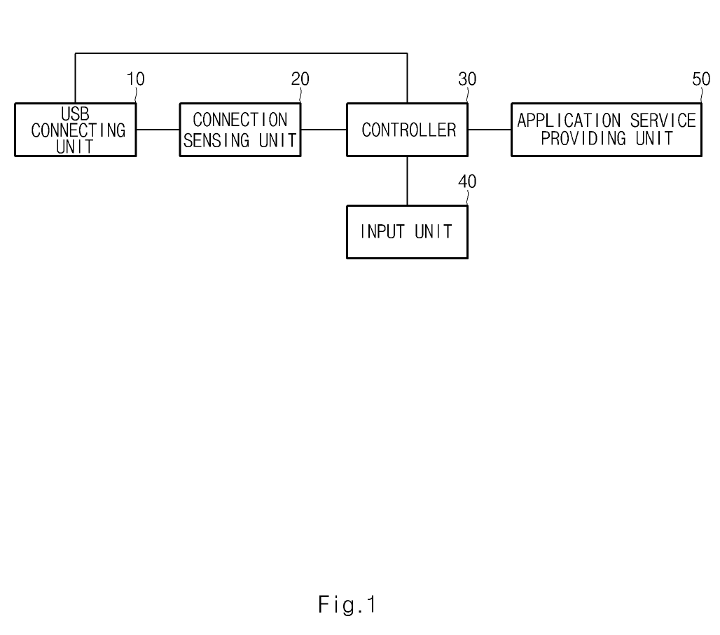

FIG. 1 is a block diagram illustrating a configuration of an apparatus for providing an application service using an external memory according to an exemplary embodiment of the present invention.

Referring to FIG. 1, an apparatus for providing an application service using an external memory includes an USB connecting unit 10, a connection sensing unit 20, a controller 30, an input unit 40, and an application service providing unit 50. The following is a description of respective structural elements. The USB connecting unit 10 may be embodied as a port in which a USB memory may be connected. On the exemplary embodiment of the present invention, an application program such as a navigation program or an electronic book program is installed on the USB memory.

The USB connecting unit 10 (e.g., a USB port) is installed in an application service providing device (e.g., a telematics terminal) included in a vehicle to interface with the USB memory. The connection sensing unit 20 senses when a USB memory is connected to the USB connecting unit 10 and reports the sensing result to a controller 30. The controller 30 executes an application program installed on the USB memory in response to the connection sensing unit 20 senses connection of an USB memory. At this time, when there are a plurality of application programs installed on the USB memory, the controller 30 makes a list for recording names of the application programs installed on the USB memory. The controller 30 provides the list to a user through the application service providing unit 50. Next, the controller 30 executes an application program selected by the user.

The application service providing unit 50 provides an application service corresponding to the application program executed by the controller 30 to the user in video and audio format. Thus, the application service providing unit 50 may include a display device and/or a speakers which are included on the vehicle.

Further, when settings are received with respect to an application service environment from a user through the input unit 40 while an application service is provided to a user through the application service providing unit 50 after executing a certain application program, the controller 30 stores those settings on the USB memory by transferring the data settings through the USB connecting unit 10.

Furthermore, when connecting an USB memory of the user with an application service providing device installed in another vehicle, a user may directly receive provisions of an application service which utilize a user's optimal environment set by the user without an additional setting procedure on the second user's vehicle. For example, when an application program installed on the USB memory is a navigation program, the controller 30 executes the navigation program installed on the USB memory and then receives and stores user setting information such as a map view type, a favorite place, a danger alarm type through the input unit 40 on the USB memory.

In another embodiment, when the application program installed on the USB memory is an electronic book program, the controller 30 executes a electronic book program installed on the USB memory and then receives and stores user setting information such as the letter size, letter shape, and background screen through the input unit 40 on the USB memory.

To execute an application program on an USB memory executed by an application service providing device included on the vehicle by an application service providing device included in another vehicle, however, an operating system (OS) of an application program on the USB memory should preferably be identical with that of the application service providing device included on the another vehicle.

The connection sensing unit 20 senses when the USB memory is connected to the application service providing device, the controller 30 determines whether OS information of an application program on the USB memory is identical with that of an application service providing device belonging to the controller 30. If the OS information of an application program on the USB memory is identical with that of an application service providing device belonging to the controller 30, the controller 30 executes the application program installed on the USB memory to provide an application service to a user. If the OS information of an application program on the USB memory differs from that of an application service providing device belonging to the controller 30, because the controller 30 may not normally execute the application program, the controller terminates the application program.

At this time, when the application program may not be normally executed since the two OSs differ from each other, the controller 30 reports this error to the user through the application service providing unit 50 (e.g., through a display (text) or speakers (audio)).

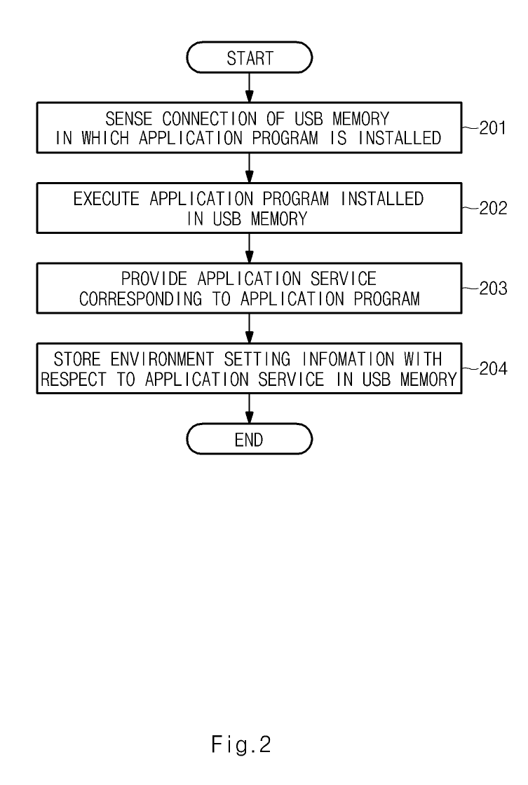

FIG. 2 is a flowchart illustrating a method for providing an application service using an external memory according to an exemplary embodiment of the present invention.

First, a connection sensing unit 20 senses connection of an USB memory in which an application program is installed with an USB connecting unit 10 (201). Next, when the connection sensing unit 20 senses a connection with an USB memory, the controller 30 executes one or more application programs installed on the USB memory (202). At this time, when there are a plurality of application programs installed on the USB memory, the controller 30 makes and provides a list (application program list) recording names of the application programs installed on the USB memory to a user through an application service providing unit 50, and then executes an application program selected by a user. Further, the controller 30 determines whether OS information of an application program on the USB memory is identical with that of an application service providing device belonging to the controller 30. If the OS information of an application program on the USB memory is identical with that of an application service providing device belonging to the controller 30, the controller 30 executes the application program installed on the USB memory and provides an application service to a user. If the OS information of an application program on the USB memory differs from that of an application service providing device belonging to the controller 30, because the controller 30 may not normally execute the application program, it terminates the application program.

Subsequently, the application service providing unit 50 provides an application service corresponding to an application program executed by the controller 30 to the user (203). Next, when one or more user settings are received with respect to an application service through the input unit 40, the controller 30 stores the one or more settings on the USB memory (204).

Through the foregoing procedure, through the use of only a USB memory, the user may use an application service providing device included in another vehicle as an application service providing device having the same settings as though the user were operating the application in his or her own car.

Furthermore, a navigation program and an electronic book program have been described as examples of an application program of the present invention. However, the present invention is not limited thereto.

Furthermore, the present invention may be embodied as computer readable media on a computer readable medium containing executable program instructions executed by a processor. Examples of the computer readable mediums include, flash memory and other forms of portable memory devices. The computer readable recording medium can also be distributed in network coupled computer systems so that the computer readable media may be stored and executed in a distributed fashion.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. An apparatus for providing an application service using an external memory in an application service providing device included in a vehicle, the apparatus comprising:
an USB connection unit configured to connect a USB memory, wherein one or more application programs are installed on the USB memory;
a connection sensing unit configured to sense when the USB memory is connected to the USB connection unit;
a controller configured to execute the one or more application programs installed on the USB memory when a connection of the USB memory is sensed; and
an application service providing unit configured to provide one or more application services which correspond to the one or more application programs executed by the controller to a user.

2. The apparatus of claim 1, further comprising an input unit configured to receive one or more user settings and selection information with respect to one or more application services from a user.

3. The apparatus of claim 2, wherein the controller stores user settings and selection information input through the input unit ton the USB memory.

4. The apparatus of claim 2, wherein the controller makes a list of a plurality of application programs installed on the USB memory when there are the plurality of application program installed on the USB memory, wherein the list is provided through the application service providing unit, and executes each application selected by the user through the input unit.

5. The apparatus of claim 1, wherein the application program comprises at least one of a navigation program and an electronic book program.

6. An apparatus for providing an application service in a vehicle, the apparatus comprising:
an USB connecting unit to which an USB memory is connected, wherein one or more application programs are installed on the USB memory;
a connection sensing unit configured to sense a connection of the USB memory;
a controller configured to check an operating system of each application program installed on the USB memory when the connection of the USB memory is sensed, and execute each application program when the checked operating system of an application program is identical with that of an application service providing device belonging to the controller; and
an application service providing unit configured to provide an application service corresponding to each application program executed by the controller to a user.

7. The apparatus of claim 6, further comprising an input unit configure to receive one or more environmental user settings and selection information with respect to an application service of the one or more application services from a user.

8. The apparatus of claim 7, wherein the controller stores the environmental settings and selection information input through the input unit on the USB memory.

9. The apparatus of claim 7, wherein the controller makes a list of a plurality of application programs installed on the USB memory when there are the plurality of application program installed on the USB memory, wherein the list is provided through the application service providing unit, and executes each application selected by the user through the input unit.

10. A method for providing an application service in an application service providing device included in a vehicle, the method comprising:
sensing, by a connection sensing unit, a connection of an USB memory on which one or more applications are installed;
checking, by a controller, an operating system of each application program installed on the USB memory;
executing, by the controller, an application program of the one or more applications when the checked operating system of the application program is identical with that of the application service providing device;
providing, by the application service providing unit, an application service corresponding to each executed application program; and
terminating, by the controller, each application program when the operating system of that application program differs from that of the application service providing device.

11. The method of claim 10, further comprising storing environmental user settings and selection information with respect to one or more application services on the USB memory when the environmental user settings and selection information is received by the controller.

12. The method of claim 10, wherein executing the application program comprises:
making a list, by the controller, of a plurality of application programs installed on the USB memory when there are the plurality of application program installed on the USB memory; and
providing the list to a user and executing each application selected by the user.

13. A computer readable medium containing executable program instructions executed by a processor, comprising
program instructions that sense a connection of a USB memory device, wherein one or more application programs are installed on the USB memory device;
program instructions that an operating system of each application program installed on the USB memory;
program instructions that execute one or more application programs when the checked operating system of an application program is identical with that of the application service providing device;
program instructions that provide one or more application services corresponding to the one or more executed application programs; and
program instructions that terminate the application program when the operating system of the application program differs from that of the application service providing device.

14. An apparatus comprising:
a port configured to connect a external flash memory device, wherein one or more application programs are installed on the external flash memory device;
a sensing unit configured to sense when the external flash memory device is connected to the port;
a controller configured to execute the one or more application programs installed on the external flash memory device when a connection of the external flash memory device is sensed; and
an audio display unit configured to provide one or more application services which correspond to the one or more application programs, executed by the controller, to a user.

15. The apparatus of claim 14, wherein the external flash memory device is a USB flash memory device.
